(19) United States
(12) Patent Application Publication
(10) Pub. No.: US 2011/0082991 A1
(43) Pub. Date: Apr. 7, 2011

(54) REMOTE BACKUP WITH LOCAL BUFFERING

(75) Inventors: Christian Leman, Austin, TX (US); David Bouteruche, Austin, TX (US); Grant Barry, Cysoing (FR)

(73) Assignee: SOFTTHINKS SAS, Villeneuve d'Ascq (FR)

(21) Appl. No.: 12/795,505

(22) Filed: Jun. 7, 2010

Related U.S. Application Data
(60) Provisional application No. 61/248,318, filed on Oct. 2, 2009.

(51) Int. Cl. G06F 12/16; G06F 12/00; G06F 12/14; G06F 15/16

(52) U.S. Cl. 711/162; 709/232; 711/163; 711/E12.001; 711/E12.103; 711/E12.093

(57) ABSTRACT

A method and system for performing a backup operation at a local-area network (LAN) including at least one LAN device and a LAN gateway (GW) includes adding backup data to a local backup archive coupled to the LAN. A request to send backup data may be sent to a data center accessible via a wide-area network (WAN). The data center may indicate authorization to send the backup data. The local backup archive may then be sent to the data center, which may generate a secure backup archive at one or more remote locations. The local backup archive may be sent at an advantageous time with respect to LAN/WAN network availability. After the secure backup archive has been successfully created, the GW may be notified and may then delete the local backup archive.

### BACKGROUND

1. Field of the Disclosure

The present disclosure relates to backup operations, and in particular, to network backup operations with local buffering.

2. Description of the Related Art

As the amount of digital data generated by users of computer systems grows, a commensurate need for backup systems and methods increases. Certain local-area network (LAN) installations, such as home networks, may be equipped to access a wide-area network (WAN) via a gateway (GW) bridging the LAN with the WAN. Backup operation of data on a LAN device may be performed directly to a remote data center via the WAN, but may be undesirable due to cost and availability of WAN bandwidth, limited storage resources, and excessive time and/or computing resources involved with the backup operation.

### BRIEF DESCRIPTION OF THE DRAWINGS

FIG. 1 is a block diagram of selected elements of an embodiment of a backup system;

FIG. 2 is a flow diagram of selected elements of an embodiment of a backup method;

FIG. 3 is a flow diagram of selected elements of an embodiment of a backup method;

FIG. 4 is a block diagram of selected elements of an embodiment of a network device;

FIG. 5 is a block diagram of selected elements of an embodiment of a gateway device; and

FIG. 6 is a block diagram of selected elements of an embodiment of a data center device.

### DESCRIPTION OF THE EMBODIMENT(S)

In one aspect, a disclosed method for backing up a LAN device may include receiving a request from the LAN device for a backup application, and in response to the request sending executable code corresponding to the backup application to the LAN device. The method may further include receiving, from the LAN device, an indication of backup data to include in a local backup archive, receiving backup data corresponding to the indication from the LAN device, and adding the received backup data to the local backup archive. The local backup archive may be stored on a local storage medium coupled to the LAN. The method may also include sending the local backup archive to a data center via a WAN. The data center may be configured to receive local backup archives from a plurality of LANs.

In certain embodiments, the indication of backup data may include a filename, a directory name, a storage location, a volume name, a storage address, a storage device identifier, or a combination thereof. The executable code corresponding to the backup application may be received from the data center via the WAN prior to sending the executable code to the LAN device. The executable code corresponding to the backup application may be configured to receive user input when executing on the LAN device. The local storage medium may be included within a gateway device bridging the LAN with the WAN.

Method operations associated with sending the local backup archive to the data center may include sending the local backup archive at an advantageous time, based on available bandwidth on the WAN, cost of bandwidth on the WAN, cost of energy, availability of the data center, WAN capacity at the data center, storage capacity, time of day, weekday, time elapsed since a prior local backup archive was created, time elapsed since a data transmission via the WAN, or a combination thereof.

In given embodiments, the method further includes receiving from the data center a confirmation that a remote backup archive includes the local backup archive. The remote backup archive may be a copy of the local backup archive. The confirmation may include an indication that the remote backup archive is secured with a redundancy factor of at least three (3). After receiving the confirmation, the method may further include deleting the local backup archive. The method may still further include sending an indication to the LAN device that the remote backup archive has been created. The method operation of sending the backup data from the local backup archive to the data center may occur after all the backup data corresponding to the received indication has been added to the local backup archive.

In a further aspect, a disclosed gateway device for backing up data from a LAN device may include a processor configured to access memory media, a LAN adapter; and a WAN adapter. The memory media may include processor instructions executable to receive backup data from the LAN device via the LAN adapter, and store the backup data to a local backup archive. The memory media may also include processor instructions executable to send a request to a data center via the WAN adapter after the local backup archive has been created. The request may include an indication of the stored backup data in the local backup archive. The request may include a query of an availability of the data center to receive the backup data. Upon receiving a response to the request from the data center, the processor instructions may be executable to send the stored backup data to the data center via the WAN adapter. The response to the request may indicate authorization to send backup data to the data center. The response to the request may include an indication of an advantageous time to send the backup data to the data center. The data center may be configured to receive backup data from a plurality of gateway devices.

In certain embodiments, the memory media may further include processor instructions executable to receive an indication of a scope of the backup data from the LAN device, and send the stored backup data to the data center after the local backup archive corresponds to the indication of the scope of the backup data. The memory media may further include processor instructions executable to send the backup data at the advantageous time. The advantageous time may be based on available bandwidth on the WAN, cost of bandwidth on the WAN, cost of energy, availability of the data center, WAN capacity at the data center, storage capacity, time of day, weekday, time elapsed since a prior local backup archive was created, time elapsed since a data transmission via the WAN, or a combination thereof.

In particular embodiments, the gateway device itself may include the memory media and a local storage medium configured to store the local backup archive.

In yet another aspect, a disclosed computer-readable memory media may include executable instructions for performing a secure backup. The instructions may be executable to receive a request from a LAN gateway via a WAN to transfer a backup archive from the LAN via the WAN, while the backup archive may include a backup of a LAN device coupled to the LAN gateway. In response to receiving the request, the instructions may be executable to send a confirmation to the LAN gateway indicating availability to receive the backup archive. The memory media may further include instructions executable to receive the backup archive from the LAN gateway, and store the backup archive as a secured backup archive. The secured backup archive may be secured with a redundancy factor greater than one (1). The redundancy factor may be attained by storing multiple copies of the backup archive at physically separate locations. The physically separate locations may be located in different geographic regions.

In some embodiments, the memory media may further include instructions executable to, after the secured backup archive has been stored, send a message to the LAN gateway indicating that the secured backup archive has been successfully created. The memory media may still further include instructions executable to receive a request from a WAN device via the WAN to access the secured backup archive. In response to the request from the WAN device, the instructions may be executable to send archive information indicative of the secured backup archive to the WAN device via the WAN. The archive information may include a directory listing of the secured backup archive.

In one embodiment, the request may further specify at least a portion of the secured backup archive, while the memory media may further include instructions executable to send the specified portion of the secured backup archive to the WAN device via the WAN, in response to the request from the WAN device. The memory media may also include instructions executable to respond to the request via a wireless network providing service to the mobile WAN device when the WAN device is a mobile WAN device.

In still another aspect, a disclosed computer-readable memory media may include executable instructions for performing a secure backup. The instructions may be executable to receive backup data from a LAN device, and store the backup data to a local backup archive coupled to the LAN. After the local backup archive includes the backup data from the LAN device, the instructions may be executable to send a request to a data center via a WAN adapter. The request may include an indication of the stored backup data on the local backup archive. Upon receiving a response to the request from the data center, the instructions may further be executable to send the backup data to the data center via the WAN adapter, while the response may indicate authorization to send the stored backup data.

In certain embodiments, the data center may be configured to receive backup data from a plurality of gateway devices, while the instructions may be executable to send an identifier associated with the LAN to the data center. The LAN device may be a personal computer accessible via the LAN, while the backup data may include user data and system data stored on the personal computer. The WAN may be a public network, such as the Internet. The request may include a query of an availability of the data center to receive the backup data, while the response to the request may include an indication of an advantageous time to send the backup data to the data center. The memory media may further include instructions executable to send the backup data at the advantageous time. The memory media may still further include instructions executable to perform bidirectional network address translation between the WAN and the LAN. The memory media may even further include instructions executable to delete the local backup archive after receiving confirmation that the data center has successfully created a secure remote backup archive including the local backup archive.

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically or collectively. Thus, for example, widget 12-1 refers to an instance of a widget class, which may be referred to collectively as widgets 12 and any one of which may be referred to generically as a widget 12.

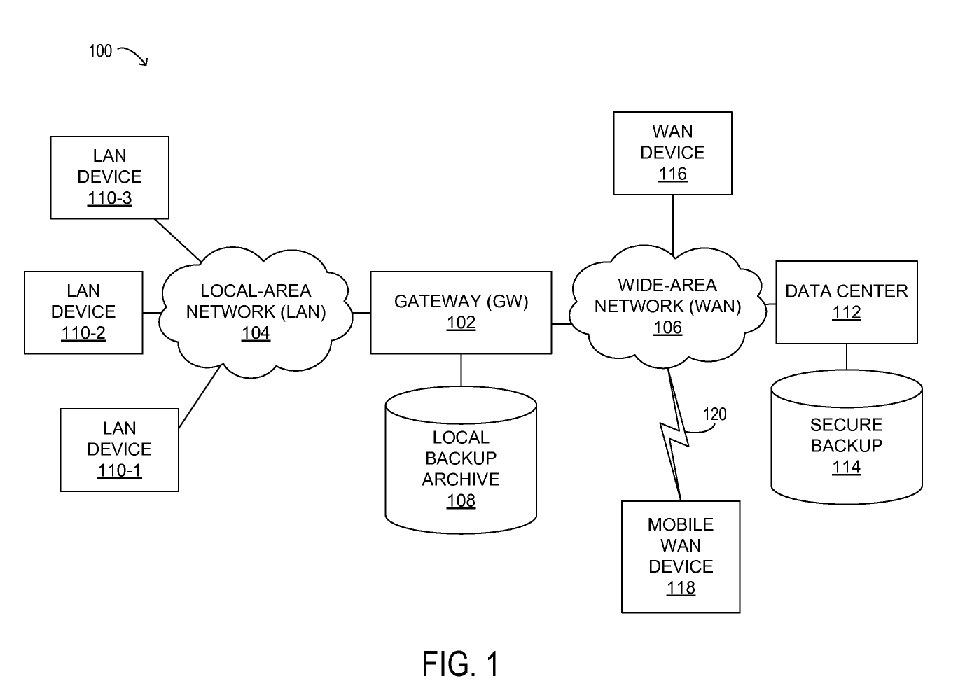

Referring now to FIG. 1, a block diagram of selected elements of an embodiment of backup system 100 is presented. Backup system 100 is depicted in generalized form for clarity. Backup system 100 includes LAN 104 and WAN 106, which are bridged by GW 102. It is noted that WAN 106 may be coupled to a plurality of LANs (not shown in FIG. 1), of which LAN 104 is depicted for clarity in backup system 100 as a single exemplary embodiment.

In FIG. 1, elements in a vicinity, or a locality, of LAN 104 may include a number of LAN devices 110 as well as GW 102. GW 102 may further be coupled to local backup archive 108, which may be accessible via LAN 104, as will be described in detail below. GW 102 may serve as a bridge to WAN 106, such that LAN devices 110 may access WAN 106 via GW 102. In various embodiments, LAN 104 may represent a fixed or wireless network, or combinations thereof.

As shown in FIG. 1, LAN devices 110 may represent any of a number of different types of computing devices configured to access LAN 104. LAN devices 110 may be fixed or mobile computer systems, handheld devices, wireless devices, or dedicated devices. For example, LAN device 110-1 may represent a desktop computer system, while LAN device 110-2 may represent a set-top box or another type of television device, such as a digital video recorder. LAN device 110-3 may further represent a notebook or tablet computer with wireless access to LAN 104. Although three (3) exemplary LAN devices 110 are shown in FIG. 1 for clarity, in other embodiments, LAN 104 may be coupled to various numbers of LAN devices 110, some of which may be replicated.

Also in FIG. 1, GW 102 may serve as a network bridge between LAN 104 and WAN 106, as mentioned previously. Accordingly, GW 102 may be configured, among other functions, to perform bidirectional network address translation between LAN 104 and WAN 106. GW 102 may also transmit various types of data between LAN 104 and WAN 106. For example, GW 102 may provide access to certain network services provided by WAN 106 or download executable code via WAN 106 for execution on LAN device 110. As will be described in detail herein, GW 102 may also be configured to upload backup data from LAN 104 to WAN 106. GW 102 may itself be a network device installed at a locality associated with LAN 104. In certain embodiments, GW 102 may be provided by a service provider of WAN 106 and/or LAN 104.

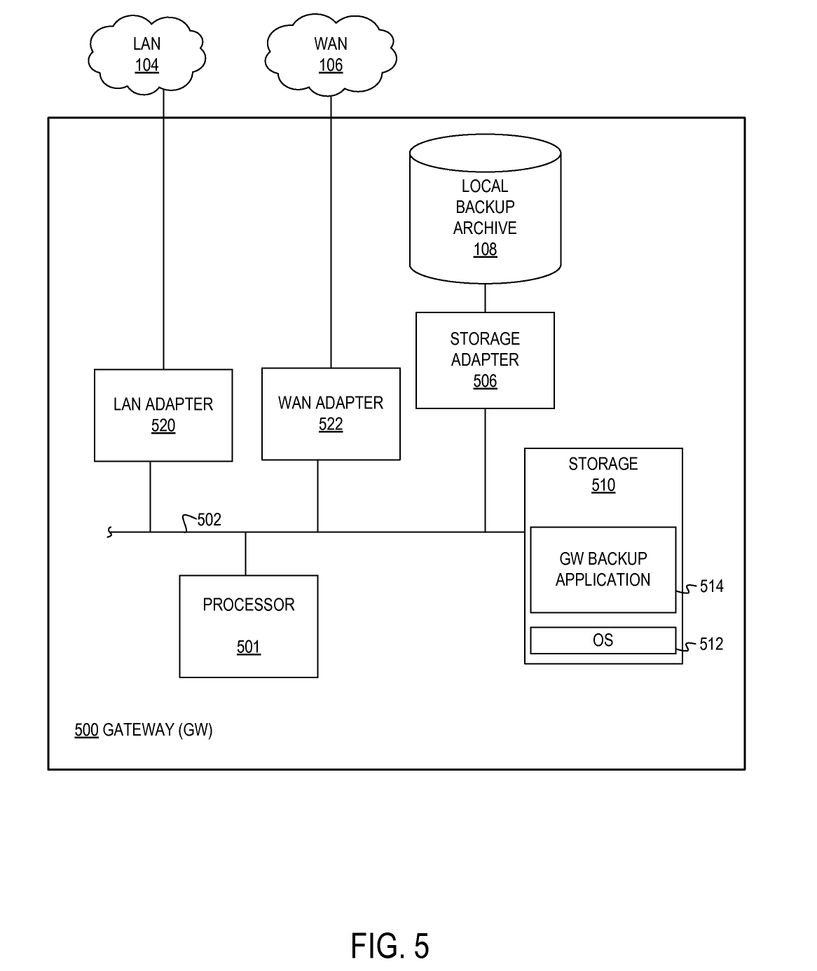

In FIG. 1, local backup archive 108 is shown coupled to GW 102, and therefore, accessible from GW 102. Local backup archive 108 may represent physical and/or logical storage of backup data originating within LAN 104. For example, local backup archive 108 may represent a local storage medium coupled to LAN 104. GW 102 may be configured, among other functions, to receive backup data from LAN device 110 and store the received backup data in local backup archive 108. Although local backup archive 108 is shown as an element coupled to GW 102 in the embodiment of backup system 100 depicted in FIG. 1, local backup archive 108 may be implemented in various other configurations and/or arrangements within LAN 104. In certain exemplary embodiments, local backup archive 108 may be included within GW 102 (see FIG. 5). In different embodiments, local backup archive 108 may also be included within another network device (not shown in FIG. 1) associated with LAN 104. Local backup archive 108 may further be configured to store and manage a plurality of individual backup archives, for example by using storage partitioning and/or a storage file system. As used herein, a “file system” refers to executable code for organizing a storage partition, such that access to the storage partition is provided using hierarchical information specifying files and directories. The hierarchical information does not specify a physical location on the storage partition on which the file system is created. The file system provides the hierarchical interpretation externally, while managing the physical location addressing of the storage partition internally. In this manner, the data in a given data file may physically occupy various locations, either segmented or contiguous, while appearing outwardly as a single contiguous entity.

Backup system 100 is also shown in FIG. 1 with data center 112, which is accessible via WAN 106 by GW 102. Data center 112 may represent centralized server infrastructure for serving a large number of client systems, for example other GWs in addition to GW 102, via WAN 106. Data center 112 may correspondingly be configured to identify individual ones of GW 102 and provide individual network services thereto. It is noted that, in certain embodiments, data center 112 itself may represent an internally distributed network of computing infrastructure, for example, comprising a number of concentrated computing hubs interconnected by backbone network segments (not shown in FIG. 1). In certain embodiments, data center 112 may include a virtual private network obtained as a service from a network provider.

Data center 112 is shown in FIG. 1 coupled to secure backup archive 114, which may represent physical and/or logical storage of backup data. In certain instances, secure backup archive 114 may represent backup data that is secured by a level of redundancy (i.e., through duplication). The level of redundancy may thus represent a number of duplicate copies generated by secure backup archive 114. The level of redundancy may also represent a tiered level of service provided by data center 112. For example, a user may select a redundancy factor of two (2) for a normally secured backup archive, while selecting a redundancy factor of three (3) or more for a highly secured backup archive, as desired. For additional security, individual redundant copies may be stored at different physical locations, which may be in different geographic regions. For example, secure backup archive 114 may include numerous remote locations, even stretching across different continents, at which individual redundant copies of backup data are stored and organized into secure backup archives. Although secure backup archive 114 is shown as an element coupled to GW 102 in the embodiment of backup system 100 depicted in FIG. 1, secure backup archive 114 may be implemented in various other configurations and/or arrangements within data center 112. In certain embodiments, at least a portion of secure backup archive 114 may be included within data center 112.

Also shown in FIG. 1 are WAN device 116 and mobile WAN device 118, which may be configured to access data center 112 via WAN 106. Data center 112 may be configured to provide access to secure backup archive 114 via WAN 106 to WAN device 116 and/or mobile WAN device 118. In certain embodiments, WAN device 116 may represent a computer executing a web browser at a remote location, while at least a portion of WAN 106 may include the Internet. Mobile WAN device 118 may access WAN 106 via wireless network 120. In particular embodiments, mobile WAN device 118 may include a cellular telephone, while wireless network 120 represents a cellular telephone network. It is noted that in certain instances, LAN device 110 may represent an embodiment of WAN device 116 for the purposes of accessing secure backup archive 114.

In operation of backup system 100, GW 102 and data center 112 may be in communication via WAN 106. GW 102 may be configured to enable network services from data center 112 to be provided at LAN 104. For example, GW 102 may receive executable programs, documents, or web pages requested by LAN device 110 from data center 112 and provide these to requesting LAN device 110. As will be described below, GW 102 may be configured, among other functions, to transmit data from local backup archive 108 to secure backup archive 114, thereby enabling backup services to be provided via WAN 106. GW 102 may further be configured to communicate with data center 112 to provide backup services for LAN 104, including uploading backup archives to data center 112 at an advantageous time after local backup archive 108 has stored backup data associated with LAN 104.

In a particular example of performing a backup operation using backup system 100, LAN device 110-1 may request download of a backup application. GW 102 may receive the request from LAN device 110-1 and provide LAN device 110-1 with executable code corresponding to the backup application. In certain embodiments, GW 102 may transmit the request to data center 112 and receive the executable code corresponding to the requested backup application from data center 112, before providing the executable code to LAN device 110-1. Thus, LAN device 110-1 may execute the requested backup application, as described above. The backup application may allow a user of LAN device 110-1 to specify data for backup and begin a backup operation. GW 102 may then store the specified backup data from LAN device 110-1 in local backup archive 108. During such time that local backup archive 108 is receiving data from LAN device 110-1, WAN 106 may remain available for unrestricted usage by LAN device 110-2 and/or LAN device 110-3. At a later time that is more advantageous for transmitting backup data via WAN 106, GW 102 may transfer backup data from local backup archive 108 to data center 112, which may store the backup data in secure backup archive 114. After receiving confirmation from data center 112 that the backup data are included in secure backup archive 114, GW 102 may delete backup data included in local backup archive 108, in order to be prepared to receive backup data for subsequent backup operations. By using local backup archive 108 as an optional temporary storage in this manner, desirable backup services may be conveniently provided via LAN 104, while maintaining certain economic advantages associated with backup services provided by data center 112 via WAN 106.

In further operation of backup system 100, WAN device 116 and/or mobile WAN device 118 may send a request to data center 112 to access to secure backup archive 114 via WAN 106. Data center 112 may authenticate the request and then respond with an indication of backup data stored in secure backup archive 114. Data center 112 may also provide access to secure backup archive 114 via WAN 106. In this manner, WAN device 116 and mobile WAN device 118 may be provided access to secure backup archive 114 from virtually any location. Accordingly, a user of LAN device 110 using backup system 100 to store backup data in secure backup archive 114, as described herein, may access their backup data using WAN device 116 and/or mobile WAN device 118.

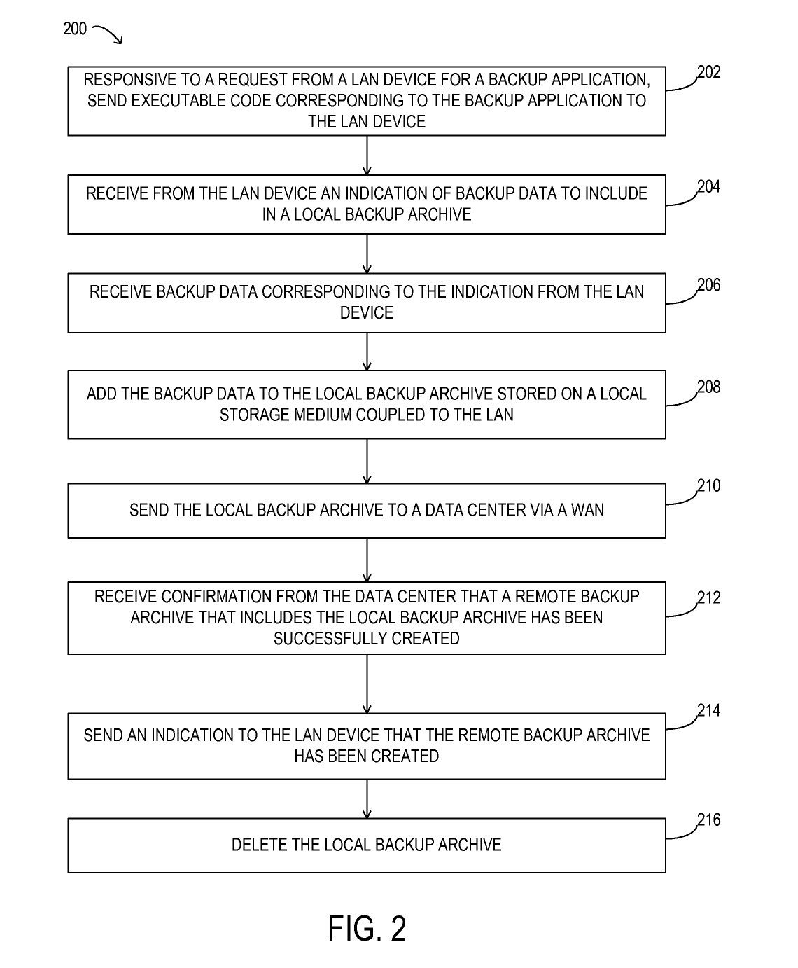

Advancing now to FIG. 2, a diagram of one embodiment of backup method 200 is illustrated in flow chart form. Method 200 may be executed by GW 102 and/or GW backup application 514 (see FIGS. 1 and 5). In various embodiments, operations in method 200 may be omitted or rearranged, as desired.

Responsive to a request from a LAN device for a backup application, executable code corresponding to the backup application may be sent to the LAN device (operation 202). The LAN device may receive and execute the executable code. The executable code corresponding to the backup application may have been received from a data center via a WAN prior to sending the executable code to the LAN device. An identifier associated with the LAN may be sent to the data center for authentication or authorization to access the data center. The executable code may be configured to receive user input when executing on the LAN device. The user input may include an indication of desired backup data stored on the LAN device. An indication of backup data to include in a local backup archive may be received from the LAN device (operation 204). The indication of backup data may include a filename, a directory name, a storage location, a volume name, a storage address, a storage device identifier, or a combination thereof. The backup data may represent any of a number of different kinds of backups, such as a full backup, a differential backup, or an incremental backup. It is also noted that the backup data may originate from one or more selected locations associated with the LAN device. In certain embodiments, method 200, or portions thereof, may be repeated for backup data associated with a plurality of LAN devices. Backup data corresponding to the indication may be received from the LAN device (operation 206). The backup data may represent user data and/or system data stored on the LAN device. The backup data may be added to the local backup archive stored on a local storage medium coupled to the LAN (operation 208). The operation of adding the backup data may continue until all the indicated backup data have been added to the local backup archive.

Then, the local backup archive may be sent to a data center via the WAN (operation 210). In operation 210, backup data may be replicated between the local backup archive and a remote backup archive coupled to the data center. Data may be sent to the data center at an advantageous time after the local backup archive has been created. The data center may send a message with an indication of the advantageous time, so that operation 210 may be scheduled accordingly. A confirmation may be received from the data center that a remote backup archive that includes the local backup archive has been successfully created (operation 212). The confirmation may include an indication that the remote backup archive has been stored as a secure backup archive, with a level of redundancy greater than one (1). An indication may be sent to the LAN device that the remote backup archive has been created (operation 214). The local backup archive may be deleted (operation 216).

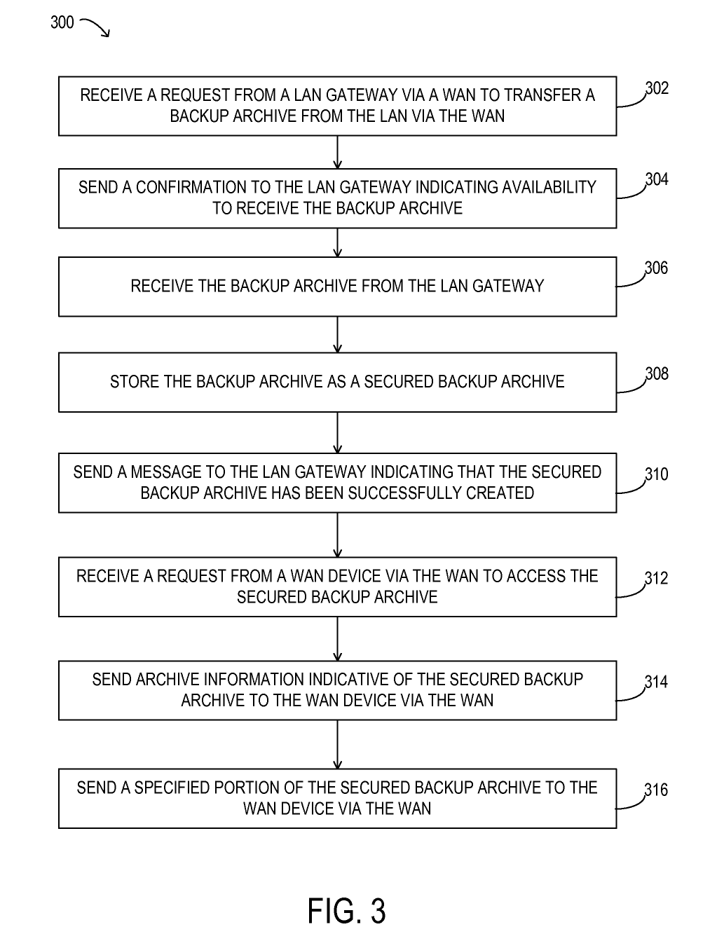

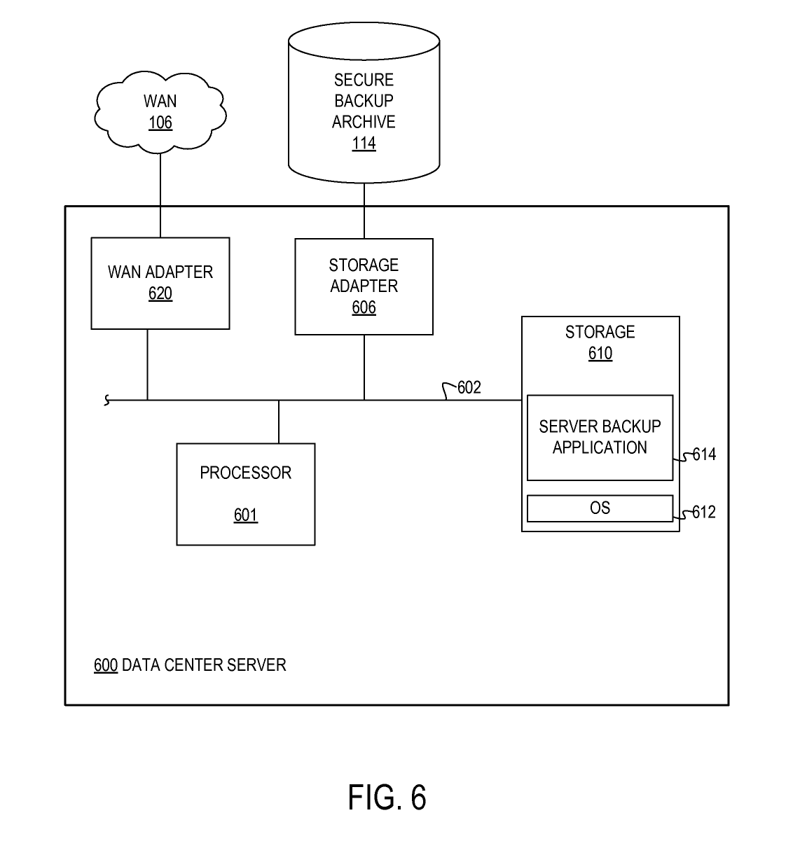

Referring now to FIG. 3, a diagram of one embodiment of backup method 300 is illustrated in flow chart form. Method 300 may be executed by data center 112 and/or server backup application 614 (see FIGS. 1 and 6). In various embodiments, operations in method 300 may be omitted or rearranged, as desired.

A request may be received from a LAN GW via a WAN to transfer a backup archive from the LAN via the WAN (operation 302). The identity of the LAN GW may be validated in association with receiving the request in operation 302. A confirmation may be sent to the LAN GW indicating availability to receive the backup archive (operation 304). In certain instances, the confirmation may indicate an advantageous time for receiving the backup archive. The backup archive may be received from the LAN GW (operation 306). The backup archive may be stored as a secured backup archive (operation 308). The secured backup archive may be associated with an identity of the LAN GW. A message may be sent to the LAN GW indicating that the secured backup archive has been successfully created (operation 310). A request may be received from a WAN device via the WAN to access the secured backup archive (operation 312). The identity of the WAN device or of a user of the WAN device may be validated or authenticated in association with receiving the request in operation 312. In certain instances, the WAN device may be a mobile WAN device, while the WAN may include a wireless network servicing the mobile WAN device. Archive information indicative of the secured backup archive may be sent to the WAN device via the WAN (operation 314). The archive information may be indicative of the contents of the secured backup archive. A specified portion of the secured backup archive may be sent to the WAN device via the WAN (operation 316). The WAN device may indicate a desired specified portion of the secured backup archive.

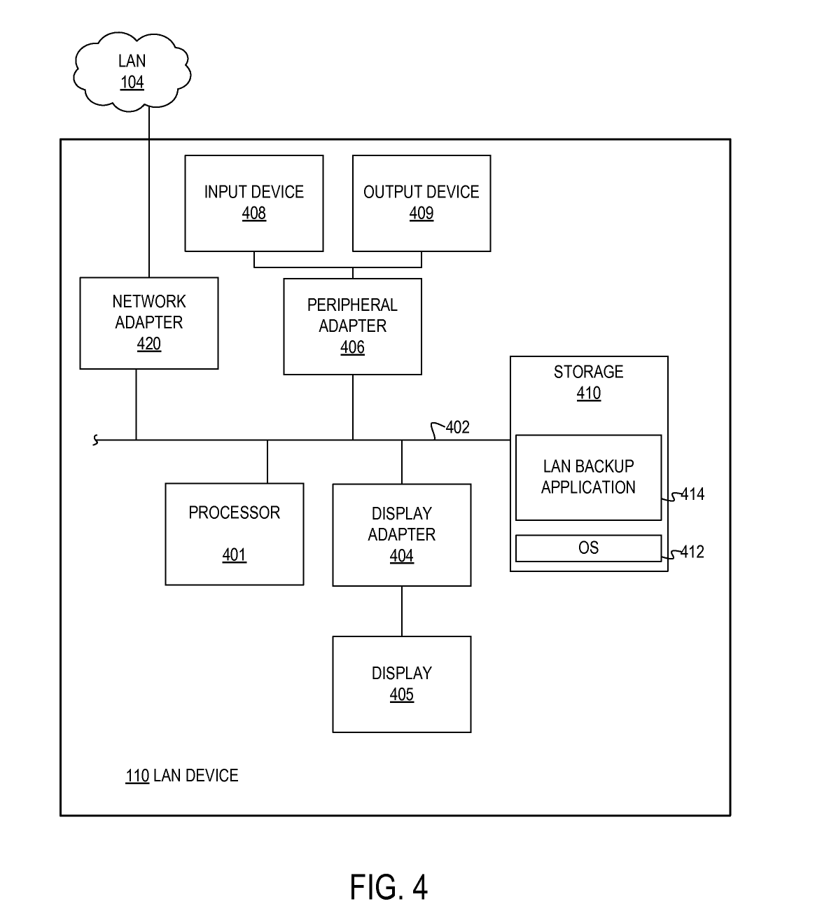

Referring now to FIG. 4, a block diagram illustrating selected elements of an embodiment of LAN device 110 is presented. In various embodiments, LAN device 110 may represent an instance of WAN device 116 (see FIG. 1).

In the embodiment depicted in FIG. 4, LAN device 110 includes processor 401 coupled via shared bus 402 to storage media collectively identified as storage 410. LAN device 110, as depicted in FIG. 4, further includes network adapter 420 that interfaces LAN device 110 to LAN 104 or another network (not shown in FIG. 4). In the embodiment depicted in FIG. 4, LAN device 110 may include peripheral adapter 406, which provides connectivity for the use of input device 408 and output device 409. Input device 408 may represent a device for user input, such as a keyboard or a mouse, or even a video camera. Output device 409 may represent a device for providing signals or indications to a user, such as loudspeakers for generating audio signals.

LAN device 110 is shown in FIG. 4 including display adapter 404 and further includes a display device or, more simply, a display 405. Display adapter 404 may interface shared bus 402, or another bus, with an output port for one or more displays, such as display 405. Display 405 may be implemented as a liquid crystal display screen, a computer monitor, a television or the like. Display 405 may comply with a display standard for the corresponding type of display. Standards for computer monitors include standards such as Video Graphics Array (VGA), Extended Graphics Array (XGA), and related vector video standards, and may further encompass digital interface standards such as Digital Visual Interface (DVI), and High-Definition Multimedia Interface (HDMI), among others. A television display may comply with standards such as National Television System Committee (NTSC), Phase Alternating Line (PAL), or another suitable standard.

Display 405 may include an output device 409, such as one or more integrated speakers to play audio content, or may include an input device 408, such as a microphone or video camera. In some embodiments, LAN device 110 may be configured without (i.e., may exclude) at least one of input device 408, output device 409, and display 405.

Storage 410 encompasses persistent and volatile memory media, fixed and removable memory media, and magnetic and semiconductor memory media. Storage 410 is operable to store instructions, data, or both. Storage 410 as shown includes sets or sequences of instructions, namely, an operating system 412 and LAN backup application 414. Operating system 412 may be a UNIX or UNIX-like operating system, a Windows® family operating system, or another suitable operating system. Examples of UNIX-like operating systems may include LINUX® and MacOS® (Apple Computer). Operating system 412 may also represent any one of a number of mobile device operating systems, such as Symbian® (Nokia), Android® (Google), Palm OS® (Palm), webOS® (Palm), Blackberry OS® (RIM), and Windows Phone 7® (Microsoft).

Referring now to FIG. 5, a block diagram illustrating selected elements of an embodiment of GW 500 is presented. GW 500 may represent an embodiment of GW 102 (see FIG. 1).

In the embodiment depicted in FIG. 5, GW 500 includes processor 501 coupled via shared bus 502 to storage media collectively identified as storage 510. GW 500, as depicted in FIG. 5, further includes LAN adapter 520 that interfaces GW 500 to LAN 104, as well as WAN adapter 522 that interfaces GW 500 to WAN 106. In certain embodiments (not shown in FIG. 5), GW 500 may include a peripheral adapter providing connectivity for the use of input devices and output devices. GW 500 is further shown in FIG. 5 including storage adapter 506, which may interface shared bus 502 to local backup archive 108 representing a storage medium.

Storage 510 encompasses persistent and volatile memory media, fixed and removable memory media, and magnetic and semiconductor memory media. Storage 510 is operable to store instructions, data, or both. Storage 510 as shown includes sets or sequences of instructions, namely, an operating system 512 and GW backup application 514 (see also FIG. 2). Operating system 512 may be a UNIX or UNIX-like operating system, a Windows® family operating system, or another suitable operating system. Examples of UNIX-like operating systems may include LINUX® and MacOS® (Apple Computer). Operating system 512 may also represent any one of a number of mobile device operating systems, such as Symbian® (Nokia), Android® (Google), Palm OS® (Palm), webOS® (Palm), Blackberry OS® (RIM), and Windows Phone 7® (Microsoft).

Referring now to FIG. 6, a block diagram illustrating selected elements of an embodiment of data center server 600 is presented. Data center server 600 may represent a server computer included in an embodiment of data center 112 (see FIG. 1).

In the embodiment depicted in FIG. 6, data center server 600 includes processor 601 coupled via shared bus 602 to storage media collectively identified as storage 610. Data center server 600, as depicted in FIG. 6, further includes WAN adapter 620 that interfaces data center server 600 to WAN 106. In certain embodiments (not shown in FIG. 6), data center server 600 may include a peripheral adapter providing connectivity for the use of input devices and output devices. Data center server 600 is further shown in FIG. 6 including storage adapter 606, which may interface shared bus 602 to secure backup archive 114 representing a storage device, a storage medium, or a storage system coupled to data center server 600.

Storage 610 encompasses persistent and volatile memory media, fixed and removable memory media, and magnetic and semiconductor memory media. Storage 610 is operable to store instructions, data, or both. Storage 610 as shown includes sets or sequences of instructions, namely, an operating system 612 and server backup application 614 (see also FIG. 3). Operating system 612 may be a UNIX or UNIX-like operating system, a Windows® family operating system, or another suitable operating system. Examples of UNIX-like operating systems may include LINUX® and MacOS® (Apple Computer). Operating system 612 may also represent any one of a number of mobile device operating systems, such as Symbian® (Nokia), Android® (Google), Palm OS® (Palm), webOS® (Palm), Blackberry OS® (RIM), and Windows Phone 7® (Microsoft).

To the maximum extent allowed by law, the scope of the present disclosure is to be determined by the broadest permissible interpretation of the following claims and their equivalents, and shall not be restricted or limited to the specific embodiments described in the foregoing detailed description.

What is claimed is:

1. A method for backing up a local-area network (LAN) device, comprising:
in response to a request received from the LAN device for a backup application, sending executable code corresponding to the backup application to the LAN device;
receiving, from the LAN device, an indication of backup data to include in a local backup archive;
receiving, from the LAN device, backup data corresponding to the indication;
adding the received backup data to the local backup archive, wherein the local backup archive is stored on a local storage medium coupled to the LAN; and
sending the local backup archive to a data center via a wide-area network (WAN).

2. The method of claim 1, wherein the indication of backup data includes at least one of: a filename, a directory name, a storage location, a volume name, a storage address, and a storage device identifier.

3. The method of claim 1, wherein the executable code corresponding to the backup application is received from the data center via the WAN prior to sending the executable code to the LAN device.

4. The method of claim 1, wherein the data center is configured to receive local backup archives from a plurality of LANs.

5. The method of claim 1, wherein the executable code corresponding to the backup application is configured to receive user input when executing on the LAN device.

6. The method of claim 1, wherein the local storage medium is included within a gateway device bridging the LAN with the WAN.

7. The method of claim 1, wherein said sending the local backup archive to the data center further comprises:
sending the local backup archive at an advantageous time, based on at least one of: available bandwidth on the WAN, cost of bandwidth on the WAN, cost of energy, availability of the data center, WAN capacity at the data center, storage capacity, time of day, weekday, time elapsed since a prior local backup archive was created, and time elapsed since a data transmission via the WAN.

8. The method of claim 1, further comprising:
receiving from the data center a confirmation that a remote backup archive includes the local backup archive.

9. The method of claim 8, wherein the remote backup archive is a copy of the local backup archive.

10. The method of claim 8, wherein the confirmation includes an indication that the remote backup archive is secured with a redundancy factor of at least three (3).

11. The method of claim 8, further comprising:
after receiving the confirmation, deleting the local backup archive.

12. The method of claim 8, further comprising:
sending an indication to the LAN device that the remote backup archive has been created.

13. The method of claim 1, wherein said sending the backup data from the local backup archive to the data center occurs after all the backup data corresponding to the received indication has been added to the local backup archive.

14. A gateway device for backing up data from a local-area network (LAN) device, comprising:
a processor configured to access memory media;
a LAN adapter; and
a wide-area network (WAN) adapter,
wherein the memory media include processor instructions executable to:
receive backup data from the LAN device via the LAN adapter;
store the backup data to a local backup archive;
after the local backup archive has been created, send a request to a data center via the WAN adapter, the request including an indication of the stored backup data in the local backup archive; and
upon receiving a response to the request from the data center, the response indicating authorization to send backup data to the data center, send the stored backup data to the data center via the WAN adapter.

15. The gateway device of claim 14, wherein the data center is configured to receive backup data from a plurality of gateway devices.

16. The gateway device of claim 14, wherein the memory media further comprise processor instructions executable to:
receive an indication of a scope of the backup data from the LAN device; and
send the stored backup data to the data center after the local backup archive corresponds to the indication of the scope of the backup data.

17. The gateway device of claim 14, wherein the request includes a query of an availability of the data center to receive the backup data, and wherein the response to the request includes an indication of an advantageous time to send the backup data to the data center, and further comprising processor instructions executable to:
send the backup data at the advantageous time.

18. The gateway device of claim 17, wherein the advantageous time is based on at least one of: available bandwidth on the WAN, cost of bandwidth on the WAN, cost of energy, availability of the data center, WAN capacity at the data center, storage capacity, time of day, weekday, time elapsed since a prior local backup archive was created, and time elapsed since a data transmission via the WAN.

19. The gateway device of claim 14, further comprising:
the memory media; and
a local storage medium configured to store the local backup archive.

20. Computer-readable memory media, including executable instructions for performing a secure backup, said instructions executable to:
receive a request from a local-area network (LAN) gateway via a wide-area network (WAN) to transfer a backup archive from the LAN via the WAN, wherein the backup archive includes a backup of a LAN device coupled to the LAN gateway;
in response to receiving the request, send a confirmation to the LAN gateway indicating availability to receive the backup archive;
receive the backup archive from the LAN gateway; and
store the backup archive as a secured backup archive.

21. The memory media of claim 20, wherein the secured backup archive is secured with a redundancy factor greater than one (1).

22. The memory media of claim 20, wherein the redundancy factor is attained by storing multiple copies of the backup archive at physically separate locations.

23. The memory media of claim 20, wherein the physically separate locations are located in different geographic regions.

24. The memory media of claim 20, further comprising instructions executable to:
after the secured backup archive has been stored, send a message to the LAN gateway indicating that the secured backup archive has been successfully created.

25. The memory media of claim 20, further comprising instructions executable to:
receive a request from a WAN device via the WAN to access the secured backup archive.

26. The memory media of claim 25, further comprising instructions executable to:
in response to the request from the WAN device, send archive information indicative of the secured backup archive to the WAN device via the WAN.

27. The memory media of claim 26, wherein the archive information includes a directory listing of the secured backup archive.

28. The memory media of claim 25, wherein the request further specifies at least a portion of the secured backup archive, and further comprising instructions executable to:
in response to the request from the WAN device, send the specified portion of the secured backup archive to the WAN device via the WAN.

29. The memory media of claim 25, further comprising instructions executable to:
when the WAN device is a mobile WAN device, respond to the request via a wireless network providing service to the mobile WAN device.

30. Computer-readable memory media, including executable instructions for performing a secure backup, said instructions executable to:
receive backup data from a local-area network (LAN) device;
store the backup data to a local backup archive coupled to the LAN;
after the local backup archive includes the backup data from the LAN device, send a request to a data center via a wide-area network (WAN) adapter, the request including an indication of the stored backup data on the local backup archive; and
upon receiving a response to the request from the data center, the response indicating authorization to send the stored backup data, send the backup data to the data center via the WAN adapter.

31. The memory media of claim 30, wherein the data center is configured to receive backup data from a plurality of gateway devices, and further comprising instructions executable to:
send an identifier associated with the LAN to the data center.

32. The memory media of claim 30, wherein the LAN device is a personal computer accessible via the LAN, and wherein the backup data include user data and system data stored on the personal computer.

33. The memory media of claim 30, wherein the WAN is a public network.

34. The memory media of claim 33, wherein the WAN is the Internet.

35. The memory media of claim 33, wherein the request includes a query of an availability of the data center to receive the backup data, and wherein the response to the request includes an indication of an advantageous time to send the backup data to the data center, and further comprising instructions executable to:
send the backup data at the advantageous time.

36. The memory media of claim 35, wherein the advantageous time is based on at least one of: available bandwidth on the WAN, cost of bandwidth on the WAN, cost of energy, availability of the data center, WAN capacity at the data center, storage capacity, time of day, weekday, time elapsed since a prior local backup archive was created, and time elapsed since a data transmission via the WAN.

37. The memory media of claim 30, further comprising instructions executable to:
perform bidirectional network address translation between the WAN and the LAN.

38. The memory media of claim 30, further comprising instructions executable to:
delete the local backup archive after receiving confirmation that the data center has successfully created a secure remote backup archive including the local backup archive.
